(19) United States
(12) Patent Application Publication
(10) Pub. No.: US 2015/0116438 A1
(43) Pub. Date: Apr. 30, 2015

(54) METHOD OF CONTROLLING OPTICAL POWER OF LASER SCANNING UNIT AND IMAGE FORMING APPARATUS FOR PERFORMING THE METHOD

(71) Applicant: Samsung Electronics Co., Ltd., Suwon-si (KR)

(72) Inventor: Su-whan KIM, Suwon-si (KR)

(73) Assignee: Samsung Electronics Co., Ltd., Suwon-si (KR)

(21) Appl. No.: 14/507,940

(22) Filed: Oct. 7, 2014

(30) Foreign Application Priority Data
Oct. 25, 2013 (KR) 10-2013-0128032

(51) Int. Cl. B41J 2/47

(52) U.S. Cl. CPC B41J 2/47
USPC 347/133

(57) ABSTRACT

An image forming apparatus may include a laser scanning unit which irradiates light to a photosensitive body to form an image; a feedback information provision unit which provides feedback information used to control optical power of the laser scanning unit; and a main controller which controls the optical power of the laser scanning unit by adjusting a voltage that is applied to the laser scanning unit by using the feedback information. The main controller performs primary optical power control by comparing a density of a sample patch formed on the photosensitive body by the laser scanning unit, the density received from the feedback information provision unit, with a target density that is previously stored and performs secondary optical power control by comparing a feedback voltage received from the feedback information provision unit with the target voltage obtained during the primary optical power control.

### CROSS-REFERENCE TO RELATED APPLICATIONS

This application claims the priority benefit of Korean Patent Application No. 10-2013-0128032, filed on Oct. 25, 2013, in the Korean Intellectual Property Office, the disclosure of which is incorporated herein in its entirety by reference.

### BACKGROUND

1. Field

One or more embodiments relate to a method of controlling optical power of a laser scanning unit, and an image forming apparatus for performing the method.

2. Description of the Related Art

A laser scanning unit generally included in a laser printer receives a control voltage from a main board and irradiates light to a photosensitive body to form an image.

Here, it is needed to control optical power generated in the laser scanning unit in order to form an image with desired density. Generally, the resistance value of a variable resistor, which is provided for each laser diode at the manufacturing time of a laser scanning unit, is manually controlled according to a designed optical power.

However, in this case, a variation in the resistance value may occur later due to a tension of the variable resistor, and after the manufacture of a laser scanning unit, the resistance value of the variable resistor cannot be changed.

Also, since the controlling is a manual operation, operation deviation between workers and omission of operations may occur.

### SUMMARY

In an aspect of one or more embodiments, there is provided a method of automatically controlling optical power of a laser scanning unit without including a variable resistor for controlling optical power, and an image forming apparatus for performing the method.

In an aspect of one or more embodiments, there is provided an image forming apparatus which includes a laser scanning unit irradiating light onto a photosensitive body and forming an image; a feedback information provision unit providing feedback information used to control optical power of the laser scanning unit; and a main controller controlling the optical power of the laser scanning unit by controlling a voltage that is applied to the laser scanning unit by using the feedback information, wherein the main controller may perform a primary optical power control by comparing a density of a sample patch formed on the photosensitive body by the laser scanning unit, which is received from the feedback information provision unit, with a target density that is previously stored, and perform a secondary optical power control by comparing a feedback voltage received from the feedback information provision unit with a target voltage obtained during the primary optical power control.

In an aspect of one or more embodiments, there is provided an image forming apparatus which includes a laser scanning unit irradiating light onto a photosensitive body to form an image; a memory provided inside the laser scanning unit and in which optical power measured by applying a test voltage to the laser scanning unit before assembling the laser scanning unit into the image forming apparatus is stored together with the test voltage; and the main controller controlling the optical power of the laser scanning unit by adjusting the voltage that is applied to the laser scanning unit based on the measured optical power and the test voltage which are stored in the memory.

In an aspect of one or more embodiments, there is provided a method of controlling the optical power of the laser scanning unit which includes forming a sample patch on a photosensitive body by applying a voltage to the laser scanning unit; performing the primary optical power control by measuring a density of a sample patch and comparing it with the target density that is previously stored; obtaining and storing a target voltage during the primary optical power control; receiving a feedback voltage from the laser scanning unit; and performing the secondary optical power control by comparing the received feedback voltage with the stored target voltage.

In an aspect of one or more embodiments, there is provided a method of controlling the optical power of the laser scanning unit includes measuring the optical power by applying the test voltage to the laser scanning unit before the laser scanning unit is assembled into the image forming apparatus; storing the test voltage and the measured optical power to a memory included in the laser scanning unit; and controlling the voltage that is applied to the laser scanning unit based on the test voltage and the measured optical power which are stored after the laser scanning unit assembled to the image forming apparatus.

According to another aspect of one or more embodiments, there is provided at least one non-transitory computer readable medium storing computer readable instructions which control at least one processor when executed in order to implement methods of one or more embodiments.

### BRIEF DESCRIPTION OF THE DRAWINGS

These and/or other aspects will become apparent and more readily appreciated from the following description of embodiments, taken in conjunction with the accompanying drawings in which:

FIG. 1 is a block diagram of an apparatus for controlling an optical power of a laser scanning unit, according to an embodiment;

FIG. 2 is a block diagram illustrating the apparatus illustrated in FIG. 1 in greater detail;

FIG. 3 is a block diagram of an apparatus for controlling the optical power of the laser scanning unit, according to an embodiment;

FIGS. 4 through 7 are flowcharts of methods of controlling the optical power of the laser scanning unit, according to embodiments;

FIGS. 8 and 9 are, respectively, a graph and a table of design of the optical power of the laser scanning unit according to an embodiment; and

FIG. 10 is a block diagram of an image forming apparatus for performing optical power controlling methods according to embodiments.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects of the present description. As used herein, the term “and/or” includes any and all combinations of one or more of the associated listed items.

Descriptions of well-known functions and constructions are omitted for clarity and conciseness.

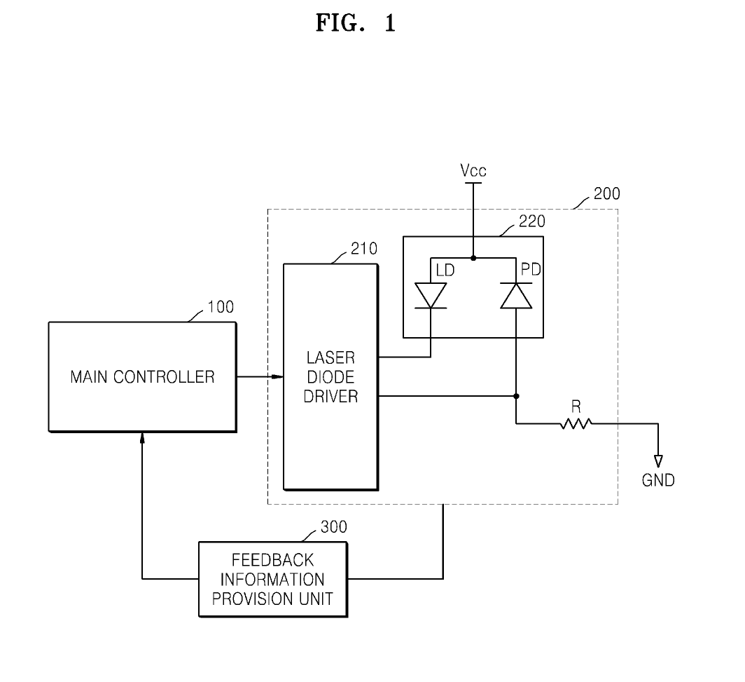

FIG. 1 is a block diagram of an apparatus for controlling an optical power of a laser scanning unit (laser scanner) 200, according to an embodiment.

Referring to FIG. 1, the apparatus according to an embodiment includes a main controller 100, the laser scanning unit 200, and a feedback information provision unit 300. Here, the laser scanning unit 200 may include a laser diode driver 210, an optical diode 220, and a resistor R. The optical diode 220 may include a laser diode LD generating light and a photo diode PD receiving light.

The main controller 100 drives the optical diode 220 by applying a driving voltage corresponding to image data about an image to be printed and a horizontal synchronization signal to the laser diode driver 210.

The main controller 100 controls the optical power of the laser scanning unit 200 by adjusting the driving voltage that is applied to the laser scanning unit 200 based on feedback information received from the feedback information provision unit (feedback information supply unit or feedback information supplier) 300.

The laser scanning unit 200 irradiates light to a photosensitive body (not illustrated) included in an image forming apparatus according to the control of the main controller 100, thereby forming an image. The laser diode driver 210 receives the driving voltage from the main controller 100 and drives the optical diode 220. The laser diode LD included in the optical diode 220 generates light having the optical power according to the driving voltage that is applied to the laser diode driver 210. An image is formed on the photosensitive body by the light generated by the laser diode LD. The photo diode PD included in the optical diode 220 receives the light generated by the laser diode LD and detects the horizontal synchronization signal.

The density of the image formed on the photosensitive body is determined by the optical power of the light irradiated by the laser scanning unit 200. In other words, when the optical power of the light irradiated by the laser scanning unit 200 increases, the density of the image formed on the photosensitive body increases. On the other hand, when the optical power of the light irradiated by the laser scanning unit 200 decreases, the density of the image formed on the photosensitive body decreases

The feedback information provision unit 300 provides the feedback information, which is for controlling the optical power of the laser scanning unit 200, to the main controller 100. In detail, the feedback information provision unit 300 provides, as the feedback information, the density of a sample patch formed on the photosensitive body by the laser scanning unit 200 and a feedback voltage detected from the laser scanning unit 200 to the main controller 100.

The main controller 100 compares the received density of the sample patch with a target density that is previously stored and performs a primary optical power control. The main controller 100 also compares the received feedback voltage with a target voltage and performs a secondary optical power control. The target voltage is obtained in the process of performing the primary optical power control.

Since the primary optical power control needs formation of the sample patch on the photosensitive body, it is difficult for the primary optical power control to be performed during a printing operation, but the secondary optical power control may be performed even during the printing operation. In addition, since the target voltage necessary for performing the secondary optical power control is obtained in the process of performing the primary optical power control, the primary optical power control is performed at intervals of a predetermined period or at intervals of a predetermined number of printing pages, and the secondary optical power control is repeatedly performed between the moments at which the primary optical power control is performed, the optical power control may be more efficiently performed.

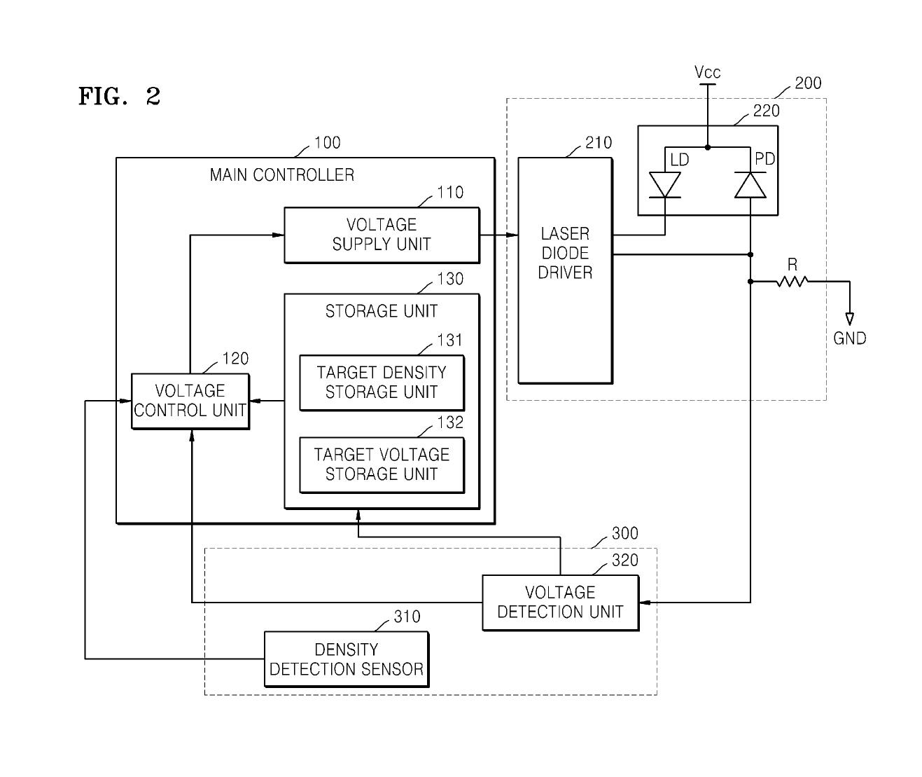

A structure of the feedback information provision unit 300 and a method for optical power control based on the feedback information will now be described in more detail with reference to FIG. 2.

FIG. 2 is a block diagram illustrating the apparatus of FIG. 1 for controlling the optical power of the laser scanning unit 200.

Referring to FIG. 2, the main controller 100 may include a voltage supply unit (voltage supply) 110 applying the driving voltage to the laser diode driver 210, a voltage control unit (voltage controller) 120 controlling the driving voltage that is applied by the voltage supply unit 110, and a storage unit (storage) 130 storing the target density and the target voltage that are necessary for the optical power control.

The feedback information supply unit (feedback information supplier) 300 may include a density detection sensor 310 detecting a density of the image formed on the photosensitive body and a voltage detection unit (voltage detector) 320 detecting the feedback voltage from the laser scanning unit 200.

A method for controlling the optical power of the laser scanning unit 200 will be described in detail below with reference to FIG. 2.

At a predetermined moment for performing the primary optical power control, the voltage supply unit 110 applies a constant driving voltage to the laser diode driver 210, and the laser diode driver 210 drives the optical diode 220 to form the sample patch on the photosensitive body. The sample patch is formed to be used to perform the optical power control through a density comparison, and may have a size, a form, and a pattern that enable the density detection.

After the sample patch is formed on the photosensitive body, the density detection sensor 310 measures the density of the sample patch and transmits the density to the voltage control unit 120. The voltage control unit 120 controls the supply voltage of the voltage supply unit 110, based on a result of comparing the density of the sensed sample patch with the target density that is previously stored in the target density storage unit (large density storage) 131. In detail, when the density of the sample patch is lower than the target density, the voltage supply unit 110 increases the driving voltage that is applied to the laser diode driver 210. On the other hand, when the density of the sample patch is higher than the target density, the voltage supply unit 110 decreases the driving voltage that is applied to the laser diode driver 210.

When the density of the sample patch is not the same as the target density, the voltage control unit 120 changes the driving voltage that the voltage supply unit 110 applies to the laser diode driver 210, and then forms a new sample patch on the photosensitive body. The density detection sensor 310 measures the density of the new sample patch and transmits the density to the voltage control unit 120. The voltage control unit 120 compares the density of the new sample patch with the target density. When the two densities are not the same as each other, the voltage control unit 120 changes the driving voltage that is applied by the voltage supply unit 110.

This process is repeated until the density of a sample patch is the same as the target density, in order to obtain a desired density, namely, desired optical power.

After the primary optical power control is performed, when the density of a sample patch is the same as the target density, the voltage detection unit 320 of the feedback information provision unit 300 detects the target voltage from the laser scanning unit 200, and transmits and stores the target voltage to a target voltage storage unit (target voltage storage) 132 of the main controller 100. Here, the target voltage is the voltage of a particular node of the laser scanning unit 200 after the optical power of the laser scanning unit 200 is controlled to become a desired value. In an embodiment illustrated in FIG. 2, the voltage of an anode of the photo diode PD included in the optical diode 220 is measured as the target voltage. However, in another embodiment, the voltage of another node which may reflect the optical power of the laser scanning unit 200 may be measured.

On the other hand, a node, which is used for measuring the target voltage, is also used for measuring the feedback voltage during the secondary optical power control. In other words, the voltage detection unit 320 transmits and stores, as the target voltage, the voltage of a specific node immediately after the primary optical power control is performed, namely, the voltage of a specific node after the optical power of the laser scanning unit 200 is adjusted to the desired value. At the moment when the secondary optical power control is performed, the voltage detection unit 320 measures the voltage of the node measured as the target voltage and transmits the voltage serving as the feedback voltage to the voltage control unit 120.

The voltage control unit 120 determines whether the measured feedback voltage is identical to the target voltage. When the feedback voltage is identical to the target voltage, it indicates that the optical power of the laser scanning unit 200 is maintained at a desired value, but if the feedback voltage is not identical to the target voltage, it indicates that, after performing the primary optical power control, the optical power of the laser scanning unit 200 is changed and deviates from the desired value. Thus, when the feedback voltage is not identical to the target voltage, the voltage control unit 120 controls the voltage supply unit 110 to adjust the driving voltage that is applied to the laser diode driver 210.

As described above, the secondary optical power control using the feedback voltage may be repeatedly, without particular timing constraint, performed between the moments at which primary optical power control is performed. Accordingly, since the optical power control is simply performed during a time interval after performing the primary optical power control and adjusting the optical power to the desired value and before next primary optical power control is performed, the primary optical power control may be supplemented.

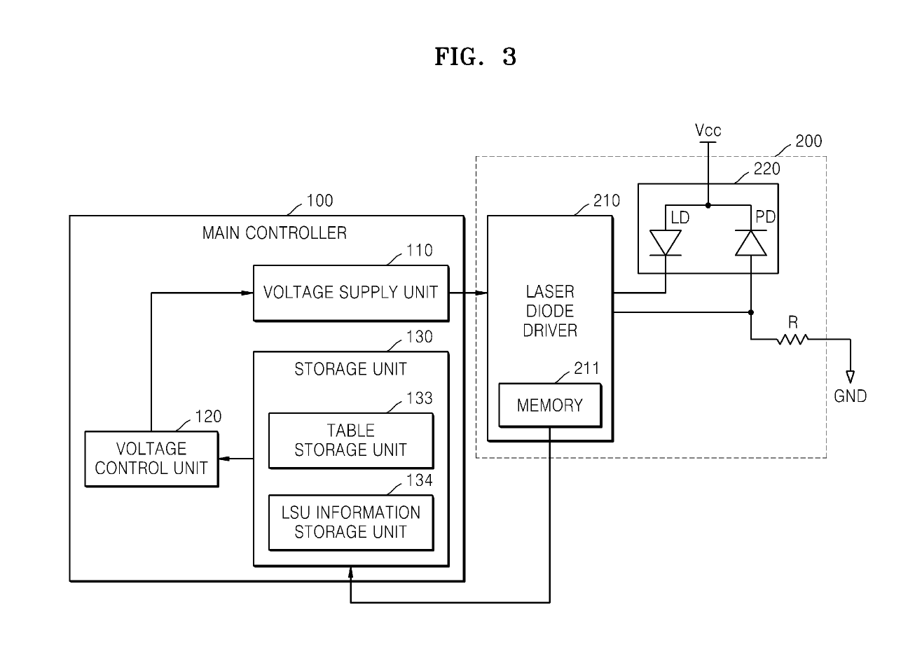

FIG. 3 illustrates a block diagram of an apparatus for controlling the optical power of a laser scanning unit 200, according to an embodiment.

Referring to FIG. 3, the apparatus includes a main controller 100 and a laser scanning unit 200. The main controller 100 may include the voltage supply unit 110 applying the driving voltage to the laser scanning unit 200, the voltage control unit 120 controlling the voltage supplied from the voltage supply unit 110, and a storage unit 130. The laser scanning unit 200 may include the laser diode driver 210, the optical diode 220, and the resistor R, and the laser diode driver 210 may include a memory 211. The optical diode 220 may include the laser diode LD and the photo diode PD.

The laser scanning unit 200 illustrated in FIG. 3 stores the optical power response characteristics of the laser scanning unit 200 during production of the laser scanning unit 200, namely, before the laser scanning unit 200 is assembled into the main controller 100. When the laser scanning unit 200 is assembled into the main controller 100, the apparatus transmits and stores the stored optical power response characteristics to the main controller 100. The main controller 100 controls the optical power of the laser scanning unit 200 by using an optical power design table that is previously stored and the optical power response characteristics received from the laser scanning unit 200.

The optical power response characteristics denote information about a test voltage that is applied to the laser scanning unit 200 and optical power measured in correspondence to the test voltage. In other words, the optical power measured by applying an arbitrary test voltage to the laser scanning unit 200 is stored as the optical power response characteristics, together with the test voltage.

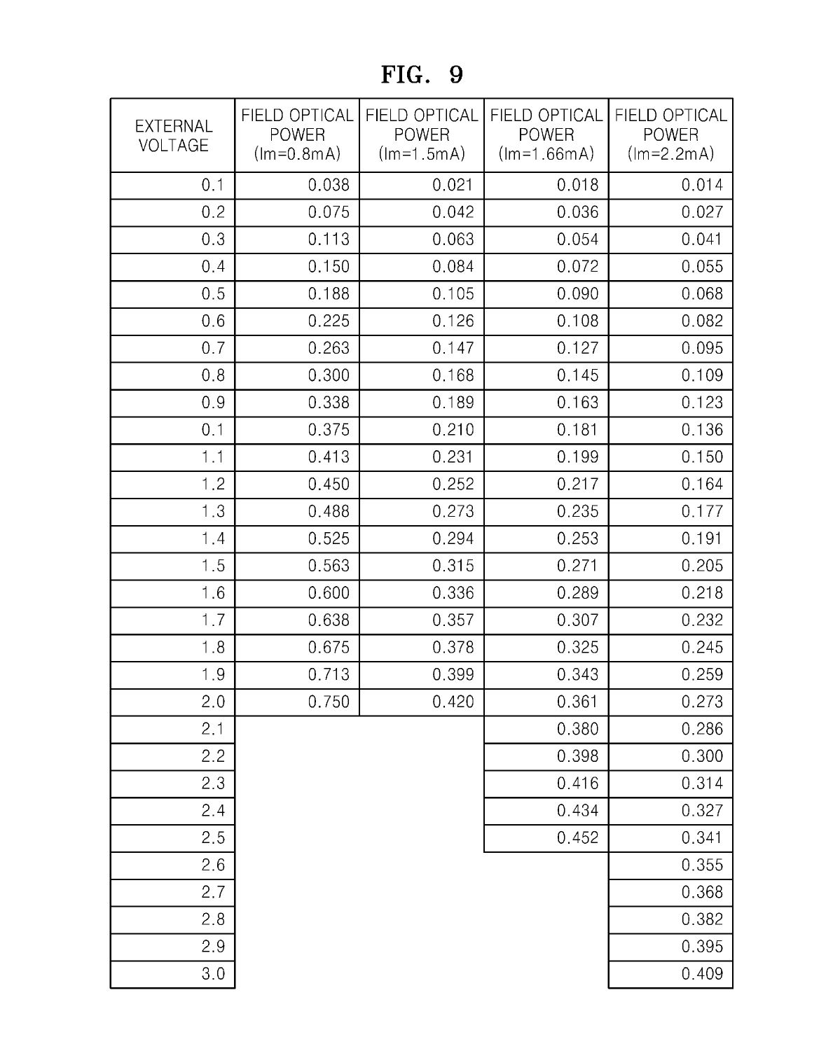

The optical power design table denotes a table including information about optical power that is previously designed according to voltages applied to the laser scanning unit 200. An example of the optical power design table is illustrated in FIG. 9. Referring to FIG. 9, the optical power design table includes optical power values that are anticipated according to the voltages applied to the laser scanning unit 200, and optical power corresponding to any one voltage individually exists per a monitor current Im. The monitor current Im denotes a current flowing in the photo diode PD included in the optical diode 220 of the laser scanning unit 200.

An operation process of the unit of FIG. 3 for controlling the optical power of the laser scanning unit 200 will now be described in detail.

Before the laser scanning unit 200 produced is assembled into the main controller 100, namely, before the laser scanning unit 200 is assembled into an image forming apparatus, a test voltage with an arbitrary value is applied to the laser diode driver 210, and optical power generated at this time is measured. The applied test voltage and the measured optical power are stored in the memory 211 included in the laser diode driver 210. The memory 211 may be realized as a non-volatile memory such as Electrically Erasable and Programmable ROM (EEPROM).

When the laser scanning unit 200 is combined with the main controller 100, namely, assembled into the image forming apparatus, the test voltage and the measured optical power stored in the memory 211 are transmitted to and stored in a Laser Scanning Unit (LSU) information storage unit 134 of the main controller 100. The voltage control unit 120 performs voltage control so that a target optical power that is previously set is generated using the information stored in the LSU information storage unit 134 and the optical power design table that is previously stored in a table storage unit 133. Since the test voltage and the optical power are stored in the LSU information storage unit 134 together with an ID of the laser scanning unit 200, the history of the laser scanning unit 200 may be easily managed.

In other words, the voltage control unit 120 compares the measured optical power stored in the LSU information storage unit 134 with the target optical power that is previously set, and if they are not identical, searches for a voltage with which the laser scanning unit 200 may generate the target optical power by using the optical power design table. In detail, the voltage control unit 120 searches the optical power design table for a monitor current value of the photo diode PD corresponding to the test voltage and the measured optical power, searches the optical power design table for a voltage corresponding to the monitor current value and the target optical power, and controls the voltage supply unit 100 to supply this voltage.

Concrete monitor current values and voltage values will now be illustrated and described with reference to the optical power design table illustrated in FIG. 9. If the voltage that is applied to the laser diode driver 210 before the laser scanning unit 200 is assembled into the main controller 100 is 1.0 V and the optical power measured at this time is 0.181 mW, these values are stored in the memory 211. When the laser scanning unit 200 is combined to the main controller 100, the test voltage of 1.0 V and the optical power of 0.181 mW stored in the memory 211 are transmitted to and stored in the LSU information storage unit 134.

It is assumed that a target optical power of 0.21 mW is previously stored in the storage unit 130 of the main controller 100. The voltage control unit 120 compares the optical power of 0.181 mW stored in the LSU information storage unit 134 with the target optical power of 0.21 mW. Since the two values are not identical, the voltage control unit 120 searches for a driving voltage for generating the target optical power by using the optical power design table stored in the table storage unit 133.

Referring to the table of FIG. 9, a monitor current corresponding to the test voltage 1.0 V and the optical power of 0.181 mW is found to be 1.66 mA, and a driving voltage enabling generation of optical power of 0.217 mW, which is nearest to the target optical power of 0.21 mW in the monitor current of 1.66 mA, is found to be 1.2 V. Thus, the voltage control unit 120 controls the voltage supply unit 110 to supply the driving voltage of 1.2 V to the laser diode driver 210.

As described above, a test voltage is applied before the laser scanning unit 200 is assembled into the image forming apparatus, the optical power is measured and stored, and the measured optical power is transmitted to and stored in the main controller 100 when the laser scanning unit 200 is assembled into the image forming apparatus. Thus, the main controller 100 may control the laser scanning unit 200 to generate desired optical power by using the optical power design table that is previously stored.

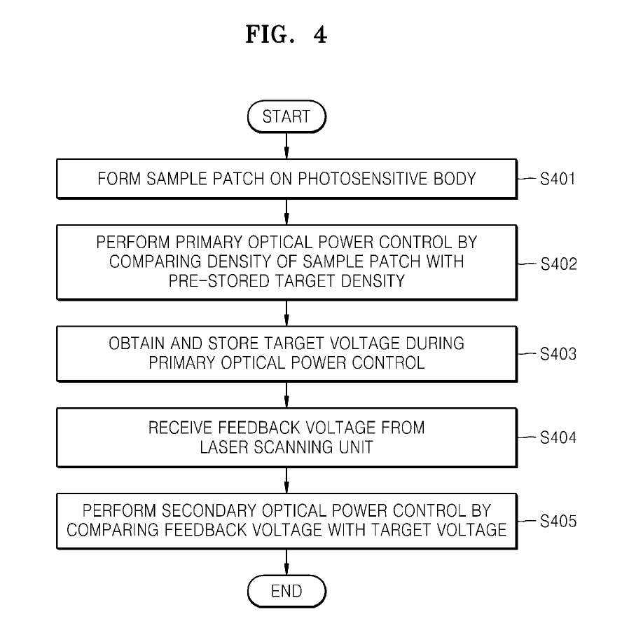

FIGS. 4 through 7 are flowcharts of methods of controlling the optical power of a laser scanning unit, according to embodiments.

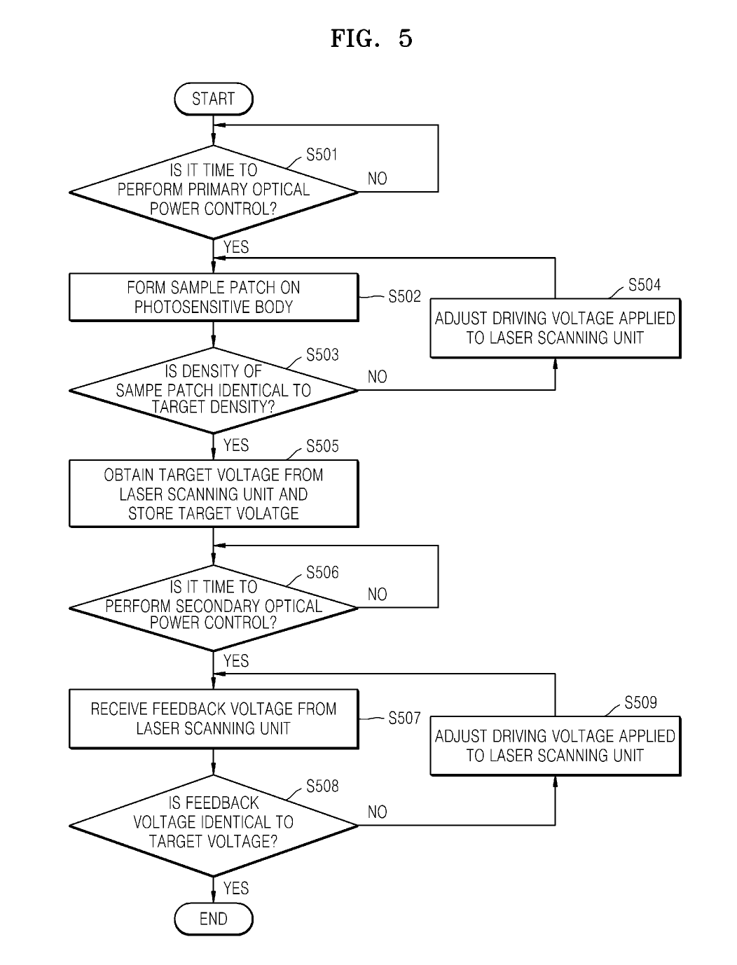

FIGS. 4 and 5 are flowcharts of a controlling method using the apparatus of FIGS. 1 and 2 for controlling the optical power of the laser scanning unit. Referring to FIG. 4, in operation S401, a driving voltage is applied to the laser scanning unit and a sample patch is formed on a photosensitive body. After the sample patch is formed, the density of the sample patch is measured using a density detection sensor. Then, in operation S402, the primary optical power control is performed by comparing the measured density of the sample patch with a target density that is previously stored. In detail, if the measured density of the sample patch is not identical to the target density, a driving voltage which is to be applied to the laser scanning unit is adjusted. Anew sample patch is formed, and the density of the new sample patch is measured and compared with the target density. This process is repeatedly performed until the density of a formed sample patch is identical to the target density. The primary optical power control may be performed at intervals of a predetermined time or at intervals of a predetermined number of printing pages.

After the optical power of the laser scanning unit is adjusted to the desired value after performing the primary optical power control, a target voltage is obtained from the laser scanning unit and stored, in operation S403. In operation S404, a feedback voltage is received from the laser scanning unit. The target voltage may be a voltage of a particular node of the laser scanning unit. Since a node of which voltage is measured as the target voltage is identical to a node of which voltage is measured as the feedback voltage, the target voltage denotes the value of a feedback voltage after the laser scanning unit is controlled to generate the desired optical power.

Lastly, in operation S405, the secondary optical power control is performed by comparing the feedback voltage with the target voltage. In detail, if the feedback voltage is not identical to the target voltage, a driving voltage which is to be applied to the laser scanning unit is adjusted, and a new feedback voltage is received and compared with the target voltage. This process is repeatedly performed until the feedback voltage is identical to the target voltage. The secondary optical power control may be repeatedly performed between the moments at which the primary optical power control is performed.

FIG. 5 is a flowchart illustrating the optical power control method of FIG. 4 in greater detail. Referring to FIG. 5, in operation S501, it is determined whether it is time to perform the primary optical power control. Since the primary optical power control may be performed at intervals of a predetermined time or at intervals of a predetermined number of printing pages, it is checked whether a predetermined time has passed or a predetermined number of printing pages have been printed after the primary optical power control is performed.

If it is determined in operation S505 that it is time to perform the primary optical power control, the method proceeds to operation S502 to apply a driving voltage to the laser scanning unit and form a sample patch on the photosensitive body. After the sample patch is formed, the density of the sample patch is measured by using the density detection sensor. In operation S503, it is determined whether the density of the sample patch is identical to the target density.

If they are not identical, the method proceeds to operation S504 of adjusting the driving voltage which is to be applied to the laser scanning unit. Then, the method goes back to operation S502 in order to form a new sample patch on the photosensitive body. On the other hand, if the density of the sample patch is identical to the target density, the method proceeds to operation S505 to acquire the target voltage from the laser scanning unit and store the target voltage. The target voltage may be a voltage of a particular node of the laser scanning unit.

In operation 506, it is determined whether it is time to perform the secondary optical power control. In detail, since the secondary optical power control may be repeatedly performed between the moments at which the primary optical power control is performed, it is identified whether a predetermined time has passed after the previous secondary optical power control is performed.

If it is time to perform the secondary optical power control, the method proceeds to operation S507 to receive the feedback voltage from the laser scanning unit. Since the node, which is used for measuring the target voltage, is also used for measuring the feedback voltage, the target voltage denotes a value of the feedback voltage after the laser scanning unit is controlled to generate the desired optical power.

In operation S508, it is determined whether the feedback voltage is identical to the target voltage. If they are not identical, the method proceeds to operation S509 to adjust the driving voltage that is to be applied to the laser scanning unit, and the method is fed back to operation S507 to receive a new feedback voltage from the laser scanning unit.

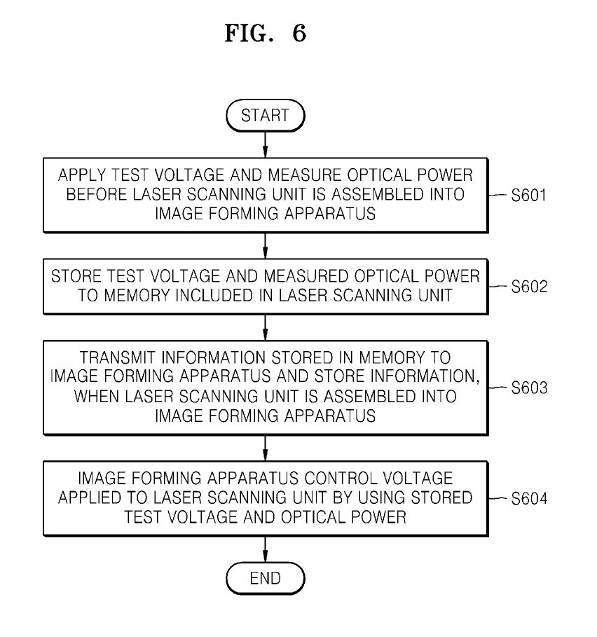

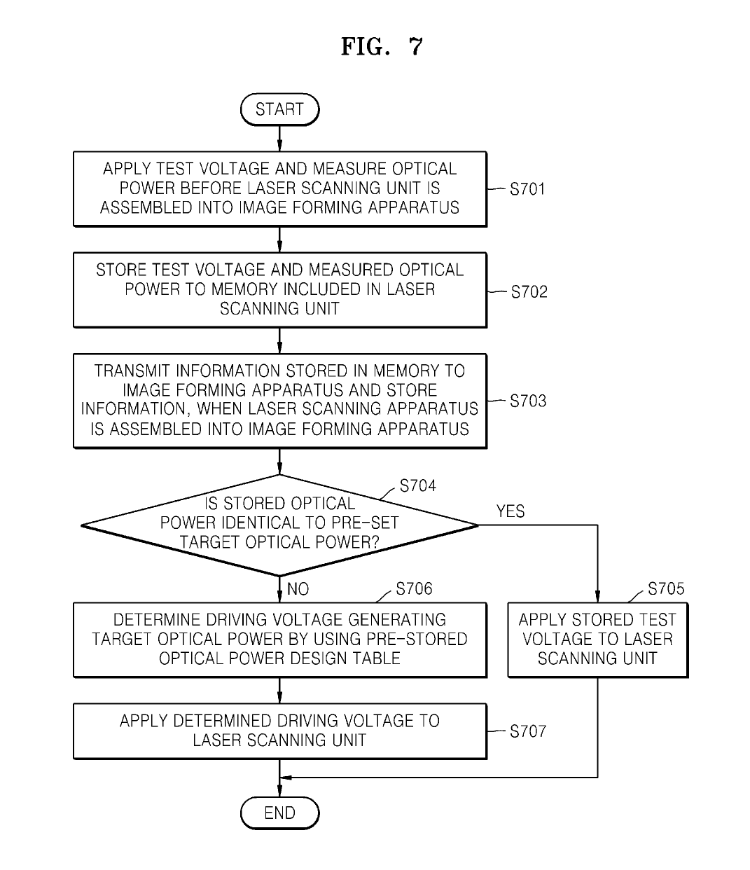

FIGS. 6 and 7 are flowcharts of a controlling method using the apparatus of FIG. 3 for controlling the optical power of the laser scanning unit.

Referring to FIG. 6, in operation S601, a test voltage is applied before the laser scanning unit is assembled into the image forming apparatus, and the optical power generated at this moment is measured. In operation S602, the test voltage and the measured optical power are stored in the memory included in the laser scanning unit. The memory may be realized as a non-volatile memory such as EEPROM.

In operation S603, the information stored in the memory is transmitted to and stored in the image forming apparatus, when the laser scanning unit is assembled into the image forming apparatus. In operation 604, the image forming apparatus adjusts the voltage that is to be applied to the laser scanning unit, by using the test voltage and the optical power that are stored in the memory. Details of operation S604 will be illustrated in FIG. 7.

Referring to FIG. 7, operations S701 through S703 are identical to operations S601 through S603 of FIG. 6, so a detailed description thereof is omitted. In operation S703, the test voltage and the measured optical power that are stored in the memory of the laser scanning unit, are transmitted to and stored in the image forming apparatus. In operation S704, it is determined whether the stored optical power is identical to the target optical power.

If they are identical, this indicates that the target optical power is generated when the test voltage is applied to the laser scanning unit, and thus the method proceeds to operation S705 to control the stored test voltage to be applied to the laser scanning unit. On the other hand, if they are not identical, the method proceeds to operation S706 to determine the driving voltage at which the laser scanning unit generates the target optical power by using the optical power design table that is previously stored. The details of the determination of the driving voltage by using the optical power design table that is previously stored will be referred to the description made above with reference to FIG. 3.

Lastly, in operation S707, the driving voltage determined in operation S706 is applied to the laser scanning unit.

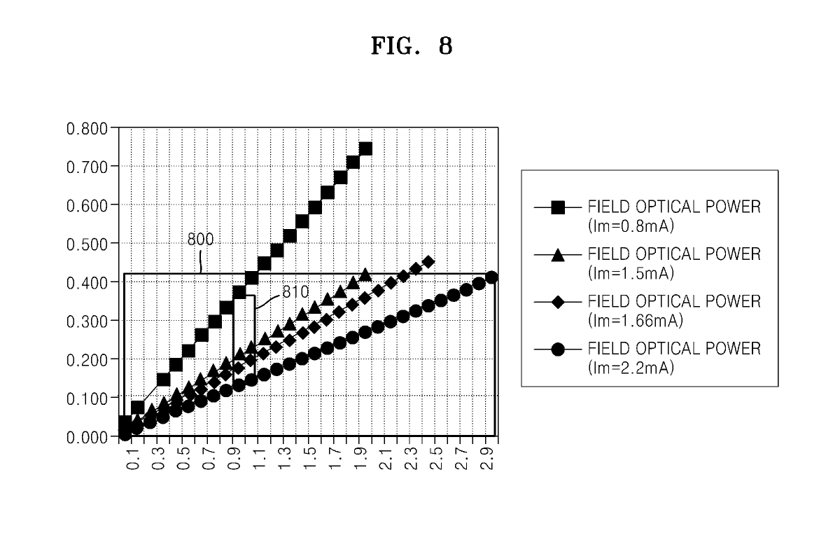

FIGS. 8 and 9 are an LSU optical power design graph and the LSU optical power design table, respectively, according to an embodiment. The LSU optical power design graph of FIG. 8 and the LSU optical power design table of FIG. 9 include information about design values of the optical power depending on the driving voltages of the laser scanning unit. In FIGS. 8 and 9, image-surface optical power denotes the optical power of light generated in the laser scanning unit measured on the surface of a photosensitive body on which an image is formed.

When producing a laser scanning unit, it is determined whether the optical power generated by the laser scanning unit is within the range of designed optical power, using the LSU optical power design graph and the LSU optical power design table. If the optical power generated by the laser scanning unit is within the range of the designed optical power, this indicates that optical power within a desired range may be generated through subsequent driving voltage control.

Referring to FIG. 8, a range 800 corresponds to a range of the optical power that is to be actually utilized, namely, an optical power utilization range. A range 810 corresponds to an optical power confirmation range. In detail, when the optical power measured with a reference voltage of 1.0 V applied as a driving voltage to the laser scanning unit exists within the optical power identification range, this indicates that the optical power of the laser scanning unit exists within the range of the designed optical power.

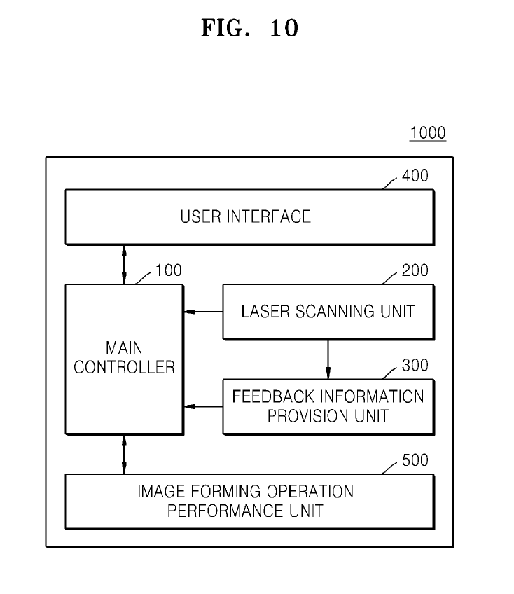

FIG. 10 is a block diagram of an image forming apparatus 1000 for performing optical power controlling methods according to embodiments. Referring to FIG. 10, the image forming apparatus 1000 may include the main controller 100, the laser scanning unit 200, the feedback information provision unit 300, a user interface unit 400, and an image forming operation performing unit 500.

The detailed structures of the main controller 100 and the laser scanning unit 200 may be identical to those of the main controller 100 and the laser scanning unit 200 illustrated in FIG. 1-2 or 3. The feedback information provision unit 300 may be selectively included, and the structure thereof may be identical to that illustrated in FIG. 1 or 2. Thus, a detailed description of operations of the main controller 100, the laser scanning unit 200, and the feedback information provision unit 300 may be referred to the description of FIGS. 1 through 3.

The user interface unit 400 receives all various inputs from a user and displays to the user information about the image forming apparatus, such as the process status of a printing operation. The image forming operation performing unit 500 performs an image forming operation such as printing or scanning, according to the control of the main controller 100.

As described above, according to the one or more of the above embodiments, a decrease in manufacturing costs and an increase in production efficiency may be realized by eliminating a variable resistor for optical power control from a general laser scanning unit.

In addition, according to the one or more of the above embodiments, an operation deviation between workers or omission of operations may be prevented by eliminating a manual adjustment operation of the variable resistor.

It should be understood that the exemplary embodiments described therein should be considered in a descriptive sense only and not for purposes of limitation. Descriptions of features or aspects within each embodiment should typically be considered as available for other similar features or aspects in other embodiments.

Processes, functions, methods, and/or software in apparatuses described herein may be recorded, stored, or fixed in one or more non-transitory computer-readable storage media (computer readable recording medium) that includes program instructions (computer readable instructions) to be implemented by a computer to cause one or more processors to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions may be executed by one or more processors. The described hardware devices may be configured to act as one or more software modules that are recorded, stored, or fixed in one or more computer-readable storage media, in order to perform the operations and methods described above, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

While one or more embodiments have been described with reference to the figures, it will be understood by those of ordinary skill in the art that various changes in form and details may be made therein without departing from the spirit and scope of the disclosure as defined by the following claims and their equivalents.

What is claimed is:

1. An image forming apparatus comprising:
a laser scanning scanner which irradiates light to a photosensitive body to form an image;
a feedback information supplier, which provides feedback information used to control optical power of the laser scanner; and
a main controller which controls the optical power of the laser scanner by adjusting a voltage that is applied to the laser scanner by using the feedback information,
wherein the main controller performs primary optical control by comparing a density of a sample patch formed on the photosensitive body by the laser scanner, the density received from the feedback information supplier, with a target density that is previously stored, and the main controller performs secondary optical power control by comparing a feedback voltage received from the feedback information supplier with a target voltage obtained during the primary optical power control.

2. The image forming apparatus of claim 1, wherein the main controller performs the primary optical power control at intervals of a predetermined period or at intervals of a predetermined number of printing pages, and the main controller repeatedly performs the secondary optical power control between the moments at which the primary optical power control is performed.

3. The image forming apparatus of claim 1, wherein the main controller comprises:
a voltage supplier which applies the voltage to the laser scanner;
a voltage controller which controls the voltage which is to be applied to the laser scanner; and
a storage unit which stores the target density and the target voltage, and
the feedback information supplier comprises:
a density detection sensor which measures the density of the sample patch and transmits the measured density of the sample patch to the voltage controller; and
a voltage detector which detects the target voltage and the feedback voltage from the laser scanner and respectively transmits the target voltage and the feedback voltage to the storage unit and the voltage controller.

4. The image forming apparatus of claim 3, wherein the voltage controller adjusts the voltage that the voltage supplier applies to the laser scanner, when the density of the sample patch measured by the density detection sensor is not identical to the target density, and the voltage controller performs the primary optical power control so that the density of a new sample patch generated by the adjusted voltage is identical to the target density.

5. The image forming apparatus of claim 4, wherein the voltage controller increases the voltage of the voltage supplier when the density of the sample patch is lower than the target density, and the voltage controller decreases the voltage of the voltage supplier when the density of the sample patch is higher than the target density.

6. The image forming apparatus of claim 3, wherein the voltage detector performs the primary optical power control to detect a voltage of one terminal of an optical diode included in the laser scanner after the optical power of the laser scanner is adjusted, and the voltage detector stores the voltage as the target voltage in the storage unit.

7. The image forming apparatus of claim 6, wherein the voltage detector transmits the voltage of one terminal of the optical diode as the feedback voltage to the voltage controller, and the voltage controller adjusts the voltage of the voltage supplier so that the feedback voltage is identical to the target voltage.

8. An image forming apparatus comprising:
a laser scanner which irradiates light to a photosensitive body to form an image;
a memory which is provided within the laser scanner and in which optical power, measured by applying a test voltage to the laser scanner before the laser scanner is assembled into the image forming apparatus, is stored together with the test voltage; and
a main controller which controls the optical power of the laser scanner by adjusting a voltage that is applied to the laser scanner based on the measured optical power and the test voltage stored in the memory.

9. The image forming apparatus of claim 8, wherein the main controller comprises:
a voltage supplier which applies the voltage to the laser scanner;
a voltage controller which adjusts the voltage that is applied to the laser scanner; and
a storage unit which stores target optical power that is previously set and an optical power design table of the laser scanner.

10. The image forming apparatus of claim 9, wherein the voltage controller compares the measured optical power with the target optical power and adjusts the voltage of the voltage supplier by using the optical power design table.

11. The image forming apparatus of claim 10, wherein:
the optical power design table includes information about optical power that is previously designed according to voltages applied to the laser scanner, and
if the measured optical power is not identical to the target optical power, the voltage controller searches the optical power design table for a voltage at which the laser scanner generates the target optical power and applies the found voltage as the voltage of the voltage supplier.

12. The image forming apparatus of claim 9, wherein the measured optical power and the test voltage that are stored in the memory are transmitted to and stored in the storage unit when the laser scanner is assembled into the image forming apparatus.

13. A method of controlling optical power of a laser scanner, the method comprising:
forming a sample patch on a photosensitive body by applying a voltage to the laser scanner;
performing a primary optical power control by measuring a density of the sample patch and by comparing the measured density with a target density that is previously stored;
obtaining a target voltage during the primary optical power control and storing the target voltage;
receiving a feedback voltage from the laser scanner; and
performing a secondary optical power control by comparing the received feedback voltage with the stored target voltage.

14. The method of claim 13, wherein the primary optical power control is performed at intervals of a predetermined period or at intervals of a predetermined number of printing pages, and the secondary optical power control is repeatedly performed between the moments at which the primary optical power control is performed.

15. The method of claim 13, wherein the performing of the primary optical power control comprises:
adjusting the voltage that is applied to the laser scanner, if the measured density of the sample patch is not identical to the target density;
forming a new sample patch on the photosensitive body according to the adjusted voltage; and
comparing the density of the new sample patch with the target density,
wherein the adjusting of the voltage, the forming of the new sample patch, and the comparing are repeatedly performed until the density of the sample patch is identical to the target density.

16. The method of claim 15, wherein the adjusting of the voltage comprises increasing the voltage that is applied to the laser scanner when the density of the sample patch is lower than the target density, and decreasing the voltage that is applied to the laser scanner when the density of the sample patch is higher than the target density.

17. The method of claim 13, wherein the obtaining and storing of the target voltage comprises:
detecting a voltage of one terminal of an optical diode included in the laser scanner after the optical power of the laser scanner is adjusted by performing the primary optical power control; and
storing the measured voltage as the target voltage.

18. The method of claim 17, wherein the feedback voltage is the voltage of one terminal of the optical diode, and the performing of the secondary optical power control comprises adjusting the voltage that is applied to the laser scanner so that the feedback voltage is identical to the target voltage.

19. A method of controlling optical power of a laser scanner, the method comprising:
measuring the optical power by applying a test voltage to the laser scanner before the laser scanner is assembled into an image forming apparatus;
storing the test voltage and the measured optical power in a memory included in the laser scanner; and
controlling a voltage that is to be applied to the laser scanner, based on the stored test voltage and the measured optical power after the laser scanner is assembled into the image forming apparatus.

20. The method of claim 19, wherein the controlling of the voltage comprises comparing the measured optical power with target optical power that is previously set, and adjusting the voltage that is to be applied to the laser scanner by using an optical power design table of the laser scanner.

21. The method of claim 20, wherein:
the optical power design table includes information about optical power that is previously designed according to voltages applied to the laser scanner, and
if the measured optical power is not identical to the target optical power, the controlling of the voltage comprises searching the optical power design table for the voltage at which the laser scanner generates the target optical power, and applying the found voltage as the voltage of the voltage supplier.

22. The method of claim 19, wherein the test voltage and the measured optical power that are stored in the memory are transmitted to and stored in the image forming apparatus when the laser scanner is assembled into the image forming apparatus.
